(19) United States
(12) Patent Application Publication
(10) Pub. No.: US 2008/0123715 A1
(43) Pub. Date: May 29, 2008

(54) Silicon Refining Installation

(75) Inventors: Christian Trassy, Grenoble (FR); Yves Delannoy, Crolles (FR); Erwann Fourmond, Tullins (FR); Cyrille Ndzogha, Saint Martin d'Heres (FR); Gerard Baluais, Chambery (FR); Yves Caratini, La Ravoire (FR)

Correspondence Address: BLANK ROME LLP, 600 NEW HAMPSHIRE AVENUE, N.W., WASHINGTON, DC, 20037, US

(73) Assignees: CENTRE NATIONAL DE LA RECHERCHE SCIENTIFIQUE, Paris Cedex 16 (FR); INVENSIL, Chambery (FR)

(21) Appl. No.: 11/628,766

(22) PCT Filed: Jun. 7, 2005
(86) PCT No.: PCT/FR05/50422

§ 371 Date: Nov. 27, 2007

(30) Foreign Application Priority Data
Jun. 7, 2004 (FR) 0451117

(51) Int. Cl. C01B 33/037

(52) U.S. Cl. 373/139; 373/155; 423/348

(57) ABSTRACT

The present invention relates to a silicon refining installation, having a cold sectorized induction crucible, having its internal wall lined with a refractory material.

The present invention relates to the manufacturing of silicon to form cells of electric power generation by photovoltaic effect. This silicon of higher quality than metal-lurgical grade silicon is generally designated as solar grade silicon (SoG).

Currently, the silicon intended for photovoltaic techniques is essentially formed of rejects of the microelectronic industry, since the silicon used for photovoltaic applications may contain a proportion of impurities (on the order of one part per million) less critical than the impurity level (on the order of one part per billion) which is generally required in microelectronics.

As a second silicon source to provide silicon adapted to photovoltaic products, it has already been provided to refine the silicon manufactured for metallurgical applications. The silicon used in metallurgy basically contains several percents of impurities among which iron, titanium, boron, phosphorus, etc., which are required to be eliminated (down to much lower concentrations).

For example, document EP-A-0459421 describes a silicon purification method comprising directing an arc plasma towards the surface of a silicon melt contained in a hot silica-wall crucible (SiO₂). The high velocity of the plasma causes a motion of the melt having its intensity depending of the power of the plasma. A hot crucible with a wall made of a refractory material forms a type of industrial crucible currently used in the metal-lurgical industry.

A disadvantage of this technique is that the silicon already heated up by the electromagnetic excitation of the coil surrounding the hot crucible undergoes an additional heating due to the plasma. This additional heating typically is of several hundreds of degrees and results in that the silicon melt reaches the silica wall melting temperature. Indeed, the melting temperature of silica is by on the order of 200° C. greater than that of silicon. Under the effect of the wall melting, there thus is a risk in terms of installation security due to the possible leaking of liquid metal.

It could have been devised to increase the thickness of the silica walls. This however draws away the excitation inductive winding which is used for the silicon heating and then poses efficiency problems. In practice, a hot crucible has a limiting wall thickness of less than a few centimeters.

Another disadvantage of hot crucibles, which are generally single-piece for tightness reasons, is that in case of an incidental solidification of the melted silicon inside of the crucible, the silicon expansion due to the cooling causes a breakage of the crucible which then cannot be repaired. This disadvantage is particularly disturbing in industrial applications.

Indeed, silicon has the feature of being one of the few materials which significantly expands on cooling down and especially on passing from the liquid phase to the solid phase. Its density varies from 2.34 in the solid state to approximately 2.6 in the liquid state. The expansion which results therefrom on cooling down is significant enough to cause the breakage of a crucible.

This is among others the silicon cannot be refined in a self-crucible (crucible formed by the actual material (silicon)), since its expansion on cooling down would damage the entire installation.

In a hot induction crucible, the number of turns of the inductive winding around the crucible is relatively low. Generally, for a homogeneous distribution of the field, from a half-dozen to a dozen spirals are provided and distributed along the crucible height. The spirals are spaced apart from one another along the crucible height, still for field homogeneity reasons, and also for electric isolation reasons. Accordingly, even if the coil is itself cooled down (for example, by the flowing of water inside of the spirals), this is not sufficient to cool down the external crucible wall, if only due to the spacing between the different turns along the height thereof.

It has further already been provided to use a cold induction crucible (or sectorized crucible) to refine silicon. Document EP-1042224 of the applicant describes such a silicon refining installation method based on a cold induction crucible by means of which is organized a turbulent stirring of the silicon melt, a plasma generated by an inductive plasma torch being directed towards the melt surface to eliminate impurities.

The use of a cold crucible is currently limited by the thermal losses due to the metal walls of the crucible which are cooled down with water. In practice, a limiting temperature of the melt which is just above the melting temperature of silicon (1,410° C.) is reached.

Now, the cost of the generated purified silicon is essentially linked to the duration of the processing which conditions the necessary amount of power. To reduce this duration, it would be desirable to be able to increase the melt temperature, which is presently not possible with a cold induction crucible.

Further, in a cold induction crucible, the silicon melt does not touch the crucible walls in the high portion thereof because of the turbulent stirring. This results in a thermal shock when the silicon at 1,410° C. touches the cold wall in case of a cutting-off of the excitation of the crucible coil (be the cutting incidental or voluntary). This thermal shock generates a risk of piercing of the metal wall (generally made of copper) of the crucible. The crucible cooling water can then come into contact with the liquid metal, thus creating a significant accident risk.

The present invention aims at providing a silicon purification installation especially intended for photovoltaic applications, which overcomes the disadvantages of conventional refining installations.

The invention especially aims at providing a solution which decreases the silicon production cost by allowing an increase in the melt temperature.

The invention aims at improving the installation security in case of an incidental or voluntary cooling down of the silicon melt, causing its solidification.

The invention also aims at providing a solution compatible with the use of a plasma torch directed towards the melt surface to eliminate impurities.

To achieve these objects, as well as others, the present invention provides a silicon refining installation, comprising a cold sectorized induction crucible having its internal wall lined with a wall made of a refractory material.

According to an embodiment of the present invention, said refractory wall is itself sectorized.

According to an embodiment of the present invention, the bottom of the crucible is formed of at least two superposed refractory material soles.

According to an embodiment of the present invention, an inductive plasma torch is directed towards the free surface of a silicon load contained in the crucible.

According to an embodiment of the present invention, a metal plate is provided under one of the or the bottom refractory soles.

According to an embodiment of the present invention, said refractory wall is made of silica.

The foregoing and other objects, features, and advantages of the present invention will be discussed in detail in the following non-limiting description of specific embodiments in connection with the accompanying drawings, among which:

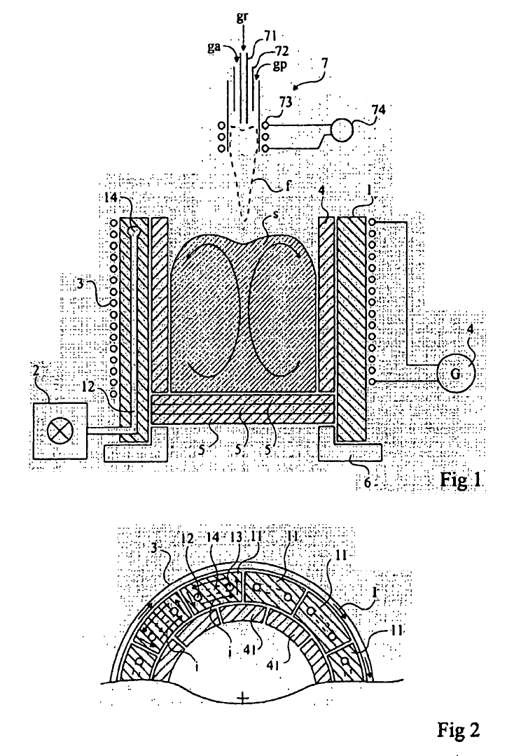

FIG. 1 very schematically shows a cross-section view of a silicon refining installation according to an embodiment of the present invention; and

FIG. 2 is a partial cross-section view of the installation of FIG. 1.

For clarity, same elements have been designated with same reference numerals in the different drawings. Only those components useful to the understanding of the present invention have been shown in the drawings and will be described hereafter. In particular, the constitutive details as well as the gases used in the plasma torch have not been detailed, the invention being compatible with conventional methods of refining by means of a plasma torch. Further, the excitation frequencies and intensities of the inductive windings have not been detailed, the invention being here again compatible with usual techniques for determining such frequencies and intensities.

A feature of the preset invention is to coat the internal wall of a cold induction crucible with a refractory lining. Preferably, this lining is not single-piece but is made, like the cold crucible, in the form of vertical sectors, the bottom of the crucible being formed of superposed refractory soles.

FIGS. 1 and 2 very schematically show, respectively, an embodiment of a silicon purification installation by a vertical cross-section and a transversal cross-section view of the crucible of this installation.

In the same way as a conventional cold induction crucible, the crucible of the invention comprises a cooled lateral sectorized wall 1. As illustrated in FIG. 2, each sector 11 of wall 1 comprises at least two ducts 12 and 13 for the flowing of a cooling liquid (generally water). This flow is vertical from one of the ends of each sector and vertical ducts 12 and 13 are connected to each other at the other end of the sector by a horizontal section 14. Conventionally in cold sectorized crucibles, the installation comprises an element 2 (FIG. 1) intended to organize the flowing of water in ducts 12 and 13 of this sector.

In the same way as a cold induction crucible, a winding 3 is wound around vertical wall 1 to enable a heating by induction of the silicon s contained in the crucible. Coil 3 is powered by a low-frequency generator 4 (G) (typically on the order of from a few tens to a few thousands of hertz). As illustrated by the arrows of FIG. 1, when a current I flows in coil 3, currents i are induced in sectors 11, which themselves induce an induction heating of the crucible silicon. For this circulation in sectors 11 to be possible, said sectors are made of metal (for example, copper) and are separated from one another and from the coil by a dielectric (air or any other insulator, for example, silica or mica).

According to the invention, the internal surface of wall 1 is lined with a wall 4 made of a refractory material. Further, the bottom of the crucible is formed of one or several soles 5 also made of a refractory material, the assembly resting by a stand 6 on a base (not shown). Soles 5 of the bottom of the crucible may be completed by an external metal plate used as elements of heat transfer towards the external air or the wall.

Preferably, wall 4 is itself formed of several vertical sectors 41 that may be arranged inside of wall 1 against one another, preferably, in such a way that their separations are not radially aligned with the separations of sectors 11 of the cooled wall.

The advantage of using a sectorized wall 4 with respect to a solid wall is that this makes easier the installation maintenance in the case where one of the sectors would be damaged. This is made possible since wall 4 is, according to the invention, no longer in charge of the mechanical holding.

Preferably, the refractory material selected for walls 4 is alumina, zirconia, or more preferably silica.

An advantage of using silica in a silicon processing application is that this minimizes the introduction of impurities into the silicon melt to be processed issuing from the actual wall.

As in a conventional plasma purification installation, an inductive plasma torch 7 is placed so that flame f of the plasma sweeps the free surface of silicon melt s. The function of the plasma is to create a medium formed of the free radicals and of the ions of the plasmageneous gas(es) in the vicinity of the free surface of the melt. The atmosphere thus created is extremely reactive and the impurities present at the melt surface combine with the reactive gas of the plasma and become volatile (or, conversely, solid) at the melt surface temperature. The entire installation is maintained under controlled atmosphere, which enables progressively evacuating the molecules containing impurities.

Plasma torch 7 for example comprises means 71 for conductive reactive gases gr to the center of the torch, concentric means 72 for conducting an auxiliary gas ga (for example, argon). A plasma gas gp (for example, also argon) is further conveyed concentrically to auxiliary gas ga. An induction coil 73 surrounds the free end of torch 7 to create the inductive plasma. Coil 73 is generally excited by an A.C. current at a frequency on the order of one megahertz by a generator 74.

Conventionally, different reactive gases may be injected into the plasma, either simultaneously or successively for their selective actions on unwanted elements.

At the beginning, the crucible is filled with silicon powder, shavings, or scraps. The silicon being a semiconductor, it must be preheated before becoming progressively conductive (around 800° C.) and being then heatable by induction by means of coil 3 of crucible 1.

For example, plasma torch 7 is first actuated to preheat the solid silicon load and bring it to the temperature providing a coupling with the low-frequency field created by coil 3 of the crucible. The gas used in this preheating phase preferably is argon. Preferably, hydrogen is introduced as a reactive gas to increase the heat conductivity of the plasma and thus accelerate the preheating of the silicon load.

At the end of this starting phase, the silicon is entirely melted and the power required to maintain this melted state is essentially provided by the crucible coil.

In a second phase, a turbulent stirring of the melt is promoted in the direction of the arrows in FIG. 1 and one or several reactive gases convenient for the elimination of impurities which, by combining with a reactive gas at the surface of melt s, form volatile species which are vaporized, are introduced into the plasma.

In a third possible phase, the silicon thus purified may be doped by elements enhancing the photovoltaic power of polysilicon by passivation of the defects, for example, by doping it with hydrogen.

The silicon, once refined and possibly doped, is emptied from the crucible. For this purpose, the crucible is in practice, as current in metallurgical processing installations, assembled on a rotary element enabling spilling its content.

The use of a cold induction crucible, heating by induction the material contained in a sort of hot crucible (wall 4), as provided by the present invention, has many advantages.

Not only does the cold crucible enable limiting the external temperature of the hot crucible but further does it form a security enclosure in case of a breakage of the hot crucible. In particular, the temperature gradient imposed by the cold wall between the inside and the outside of the crucible results in that, in case of a leakage at the hot crucible, the melted silicon which would tend to escape to the outside will be first cooled down by crossing this wall 4 before reaching cold crucible 1.

Another advantage of using a cold sectorized crucible is that it stands a mechanical deformation likely to be repaired.

Another advantage of the present invention is that the thermal gradient enables increasing the silicon melt temperature with respect to the use of a cold crucible alone. The silicon processing time is thus reduced.

Another advantage is that, even in case of an additional heating due to plasma, the melting of the refractory wall on its inner surface does not propagate across the entire thickness of the wall due to the cooling brought by the external crucible. Any risk of metal liquid leaking is thus avoided.

Another advantage of the invention is that risks of piercing of the cold crucible, traditionally linked to the thermal shock in case of a cutting-off of the coil power supply, no longer exists due to the presence of the refractory crucible.

In the low portion of the crucible, several refractory material thicknesses are sufficient to avoid any problem. Since there is no induction at the bottom, the refractory material thickness can be limitlessly increased.

In practice, surface temperature measurements have shown a possibility of increasing the temperature by at least 1500 in a crucible according to the present invention with respect to a traditional cold induction crucible. This surface temperature increase enables, in the purification process, increasing the oxygen rate in the plasma (by a factor of approximately 2.5) before forming of the slag layer which slows down the volatilization of impurities, in particular boron. The boron elimination time constant can thus be brought down from 90 to 50 minutes.

Another advantage of the present invention is that by transferring the mechanical stress to the cold metal crucible, the lining with a refractory material now only has the thermal function, which decreases its cost.

The use of a cold induction crucible preserves the advantage of a turbulent stirring in the silicon melt to favor its purification. By supplying coil 3 with a single-phase alternating voltage, the magnetic field of the crucible is itself alternating and single-phase, which has the advantage of causing a heating of the melt at the same time as a motion of the silicon. This results from flow variations inside of the melt which give rise to induced currents located at the periphery of the material (in the electromagnetic skin). This effect is especially described in above-mentioned patent application EP-1042224 of the applicant.

The selection of the supply frequencies of the coil is a function of its size and of its shape. For example, for a crucible having a diameter on the order of 20 cm that can contain a silicon load on the order of 10 kg, it can be worked with a frequency on the order of 7 kHz.

Of course, the present invention is likely to have various alterations, modifications, and improvements which will occur to those skilled in the art. In particular, the used gases will be selected according to the impurities to be eliminated. Further, the dimensions of the different elements of the installation are within the abilities of those skilled in the art based on the functional indications given hereabove and on the application. In particular, although the present invention has been described in relation with a crucible of cylindrical shape, the crucible can in practice have a tapered shape to ease its emptying of the purified silicon, provided for the diameter variation to remain compatible with an induction heating.

1. A silicon refining installation, comprising a cold sectorized induction crucible having an internal wall lined with a wall made of a refractory material.

2. The installation of claim 1, in which said refractory wall is itself sectorized.

3. The installation of claim 1, in which a bottom of the crucible is formed of at least two refractory material soles.

4. The installation of claim 1, further comprising an inductive plasma torch directed towards a free surface of a silicon load contained in the crucible.

5. The installation of claim 1, in which a metal plate is provided under at least one of the bottom refractory soles.

6. The installation of claim 1, in which said refractory wall is made of silica.

7. A process of refining silicon, comprising the step of:
placing a silicon load in a cold sectorized induction crucible;
wherein the crucible has an internal wall lined with a wall made of a refractory material.

8. The process of claim 7, wherein the step of placing a silicon load in a cold sectorized induction crucible comprises placing a silicon load in a cold sectorized induction crucible with said refractory wall which is sectorized.

9. The process of claim 7, wherein the step of placing a silicon load in a cold sectorized induction crucible comprises placing a silicon load in a cold sectorized induction crucible having a bottom formed of at least two refractory material soles.

10. The process of claim 7, further comprising directing an inductive plasma torch towards a free surface of the silicon load contained in the crucible

11. The process of claim 9, wherein the step of placing a silicon load in a cold sectorized induction crucible comprises placing a silicon load in a cold sectorized induction crucible with a metal plate provided under at least one of the bottom refractory soles.

12. The process of claim 7, wherein the step of placing a silicon load in a cold sectorized induction crucible comprises placing a silicon load in a cold sectorized induction crucible with said refractory wall made of silica.
